(19) United States
(12) Patent Application Publication
(10) Pub. No.: US 2015/0324091 A1
(43) Pub. Date: Nov. 12, 2015

(54) DETECTING VALUABLE SECTIONS IN WEBPAGE

(71) Applicants: Li-Mei Jiao, Beijing (CN); Xifei HUANG, Beijing (CN); Ping LUO, Beijing (CN)

(72) Inventors: Li-Mei Jiao, Beijing (CN); Xifei HUANG, Beijing (CN); Ping LUO, Beijing (CN)

(21) Appl. No.: 14/375,834

(22) PCT Filed: Apr. 28, 2012
(86) PCT No.: PCT/CN2012/000569

§ 371 Date: Jul. 31, 2014

(51) Int. Cl. G06F 3/0484; G06F 17/30

(52) U.S. Cl. CPC G06F 3/04842; G06F 17/30873

(57) ABSTRACT

A method for detecting a valuable section within a web page is disclosed. The method comprises: receiving an input webpage; and detecting a valuable section in the input webpage based on a user log of a reference webpage associated with the input webpage, wherein said user log comprises a path of a section within the reference webpage that was accessed by a user in a DOM-tree that represents said reference webpage.

### BACKGROUND

With the development of search engine and relative technologies, information in web pages now has already owned a good accessibility for users. However, not all parts of a web page are useful for users. There are some sections that may meet users' needs while other parts are useless like advertisement and side bars. Though users may have their personal preferences, but there are still some common valuable sections in the web page that are interesting to them.

### BRIEF DESCRIPTION OF THE DRAWINGS

The accompanying drawings illustrate various examples of various aspects of the present disclosure. It will be appreciated that the illustrated element boundaries (e.g., boxes, groups of boxes, or other shapes) in the figures represent one example of the boundaries. It will be appreciated that in some examples one element may be designed as multiple elements or that multiple elements may be designed as one element. In some examples, an element shown as an internal component of another element may be implemented as an external component and vice versa.

FIG. 1 is a block diagram of a system that may detect valuable sections in a web page according to an example of the present disclosure;

FIG. 2 is a process How diagram for a method of detecting valuable sections within a web page according to an example of the present disclosure;

FIG. 3 illustrates a framework for recommending valuable sections within a web page according to an example of the present disclosure;

FIG. 4 is a process flow diagram for another method of detecting valuable sections within a web page according to another example of the present disclosure;

FIG. 5 is a process flow diagram for yet another method of detecting valuable sections within a web page according to yet another example of the present disclosure;

FIG. 6 is a schematic diagram of a weighted tag tree according to an example of the present disclosure;

FIG. 7 is a process flow diagram for another method of detecting valuable sections within a web page according to another example of the present disclosure:

FIG. 8 is a block diagram showing a non-transitory, computer-readable medium that stores code for detecting valuable sections within a web page according to an example of the present disclosure: and

FIGS. 9(a) and 9(b) shows the recommending results for the same web pages by the original smart print and a method of the present disclosure respectively.

### DETAILED DESCRIPTION

A typical way to detect valuable sections in a web page is based on its structure features, which is also referred to as a page-based detection method. In this type of method, page segmentation is an essential pre-processing step, wherein a page is divided into sections and each section is given a different weight based on some features. These page segmentation algorithms can partition a page into several regions with different importance. A document object model (DOM)-based method to extract useful information from the HTML document of web page has been raised. A DOM is a cross-platform and language-independent convention for representing and interacting with objects in various markup language documents. Aspects of the DOM, such as its elements, may be addressed and manipulated. An element is an individual component of the particular markup language used. A DOM-tree renders these elements as nodes within a tree. A node may also correspond to a small unit of data that resides on a web page, which is also referred to as a section in this disclosure. The DOM-based method parses the DOM tree of a web page instead of its raw HTML document. As a result, time and storage consuming of HTML parsing decreases significantly.

According to the DOM-based style, some vision-based segmentation and block importance learning algorithms are developed. Besides a DOM tree structure, the vision-based algorithm also takes usual cue into consideration and can compute the importance of a region or block depending on its spatial and content features. Such methods can weight each importance of block effectively, but the meaning of importance is not always reasonable since it comes from the style of web page other than the need of users.

Another method to extract meaningful article from web pages has also been developed, in which the DOM tree and visual features are used to divide pages and extract user needed article from text node. Compared with algorithms which use all the text nodes in DOM tree, this method try to partition those nudes into several text segments. Then by finding out an optimized subsequence of text nodes in those segments, it can recommend to users a continual and valuable article. In this way, the extracted articles can keep the influence of nonsense information like advertisements or auxiliary information. Such method can provide good experience to users when they need automatic extraction of text articles, but it only provide a limited method to deal with pages having lots of texts contain like news pages, encyclopedia entries, etc.

Another DOM as id visual based method has been developed to detect print-worthy content in web page. Unlike the previous article extraction methods, this method does not only focus on text sections, but also eon select other kinds of sections like images. This method divides web pages and calculates importance weight of each block by DOM tree and visual features. The process of print-worthy section recommendation normally has three steps: web page segmentation, block importance calculation and extraction. In the segmentation step, a web page is divided into smallest elements, then these elements arc clustered into blocks or areas based on the result of affinities computing between elements. After partitioning pages into reasonable blocks, importance of each block is calculated, wherein importance is determined by the visual features of blocks and blocks which are highlight, few hyperlinks and locating high are given high importance weight. At last, recommended sections arc extracted by computing the best subtree that has the highest weight score. Following this strategy, useful sections in many kinds of pages can be extracted. But it still owns some shortcomings: first, visual matures may not reflect customers' opinions since it comes from personal experience; second, it cannot adapt to some pages very well, for example, if the text in the page is very long, then this algorithm will ignore article located at the bottom; third, it does not have an automatic process to adjust recommendation results through the feedbacks of users.

In examples of the present disclosure, instead of those page-based methods, generally accepted valuable sections in a public web page are detected based on a user log. Compared with the page-based methods, the log-based method presented herein can obtain more precise and reasonable valuable sections.

In the following, certain examples according to the present disclosure are described in detail with reference to the drawings.

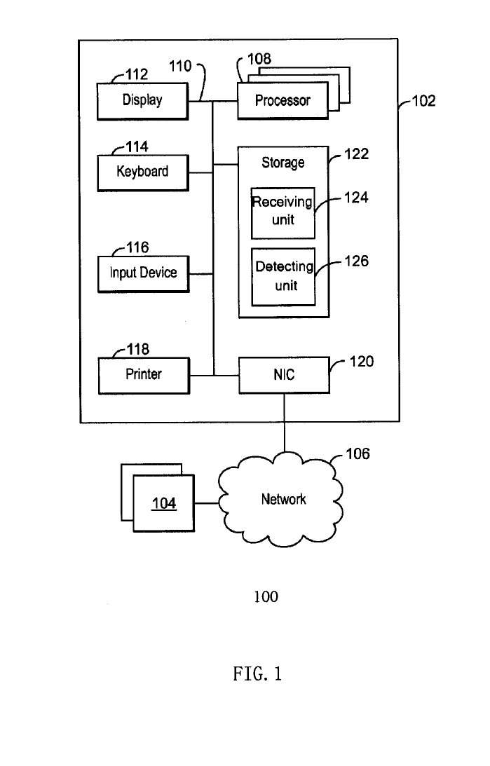

With reference to FIG. 1, FIG. 1 is a block diagram of a system that may detect valuable sections in a web page according to an example of the present disclosure. The system is generally referred to by the reference number 100. Those of ordinary skill in the art will appreciate that the functional blocks and devices shown in FIG. 1 may comprise hardware elements including circuitry, software elements including computer code stored on a tangible, machine-readable medium, or a combination of both hardware and software elements. Additionally, the functional blocks and devices of the system 100 are but one example of functional blocks and devices that may be implemented in an example. Those of ordinary skill in the art would readily be able to define specific functional blocks based on design considerations for a particular electronic device.

The system 100 may include a server 102, and one or more client computers 104, in communication over a network 106. As illustrated in FIG. 1, the server 102 may include one or more processors 108 which may be connected through a bus 110 to a display 112, a keyboard 114, one ore more input devices 116, and an output device, such as a printer 118. The input devices 116 may include devices such as a mouse or touch screen. The processors 108 may include a single core, multiple cores, or a cluster of cores in a cloud computing architecture. The server 102 may also be connected through the bus 110 to a network interface card (NIC) 120. The NIC 120 may connect the server 102 to the network 106.

The network 106 may be a local area network (LAN), a wide area network (WAN), or another network configuration. The network 106 may include routers, switches, modems, or any other kind of interface device used for interconnection. The network 106 may connect to several client computers 104. Through the network 106, several client computers 104 may connect to the server 102. The client computers 104 may be similarly structured as the server 102.

The server 102 may have other units operatively couples to the processor 108 through the bus 110. These units may include tangible, machine-readable storage media, such as storage 122. The storage 122 may include any combinations of hard drives, read-only memory (ROM), random access memory (RAM), RAM drives, flash drives, optical drives, cache memory, and the like. Storage 122 may include a receiving unit 124 and a detecting unit 126. The receiving unit 124 may receive an input webpage from which valuable sections therein may be detected. The web page may be accessed using the network 106. The detecting unit 126 detects valuable sections in the input webpage based on a user log of a reference webpage associated with the input webpage, wherein the reference webpage can be either the same webpage as the input one or a similar webpage(s) to the input webpage. A user log indicated previous usage history of a webpage by a user(s) and may comprise a path of a section within a webpage that was accessed (including clipped or printed) by the user(s) in a DOM-tree that represents this webpage. Each section or block in the page is a path of the DOM-tree which stores as an XPath in the user log. For example, an XPath HTML/BODY/DIV[1] means a path in DOM-tree which begins with HTML tag and ends with first DIV tag in the subtree of BODY tag. Such user logs can be stored in a log database (not shown) in the storage 122.

Although not shown in FIG. 1 the storage 122 may further include a determining unit which is used to determine whether there is an access record of the same page in the user log or not.

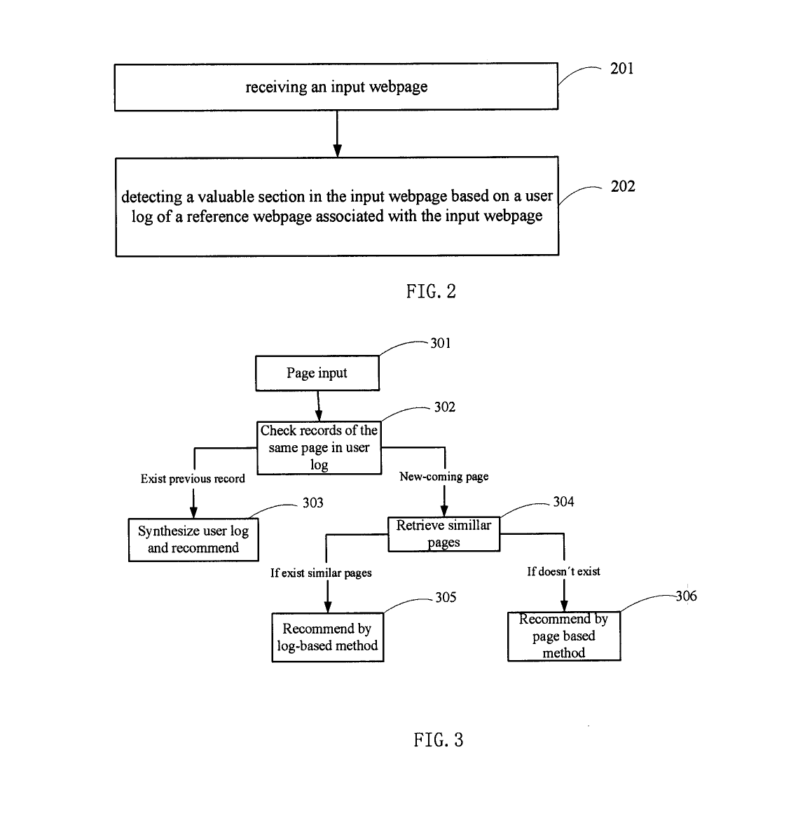

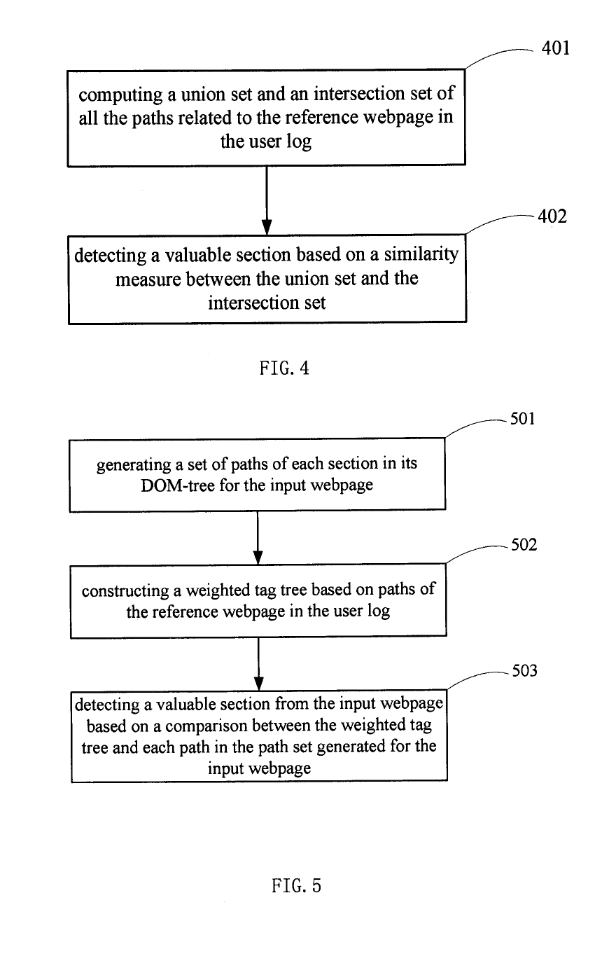

With reference to FIG. 2 now, FIG. 2 is a process flow diagram for a method of detecting valuable sections within a web page according to an example of the present disclosure. At block 201, an input webpage is received, from which valuable sections therein may be detected. The webpage can be received through the receiving unit 124 shown in FIG. 1. Then, a block 202, a valuable section in the input webpage is detected based on a user log of a reference webpage associated with the input webpage. As described above, the user log may comprise a path of a section within the reference webpage that was accessed by the user(s) in a DOM-tree that represents this reference webpage. The reference webpage associated with the input webpage can either be the same webpage that has been visited before or similar web-page(s) to the input webpage, which will be described in detail below with reference to FIG. 4 and FIG. 5 respectively.

With reference to FIG. 3, FIG. 3 illustrates a framework for detecting and recommending valuable sections within a web page according to an example of the present disclosure. As shown, after a webpage from which a valuable section may be detected is input, it is first determined whether there is an access record of the same page in the uses log or not. If there is, it indicates that this webpage has been visited before by the same or a different user(s) and the access history of this webpage can be synthesized to facilitate detection and recommendation of a valuable section in the webpage, as shown in block 303. If, on the other hand, there does not exist an access record of this webpage in the user log, then this input webpage is considered as a new-corning page and it is determined whether this input webpage has similar pages or not, as shown in block 304. Here similarity measure is in terms of structures and pages are similar if they are generated by a similar web template. If there exist similar web pages, then the log records of these similar pages are used to detect valuable sections in the new-coming page to be recommended to the user, which is as shown in block 305 and will be described in detail below. However, if there are no similar pages, then a page-based method as described above can be applied to the input webpage to detect valuable sections therein, as shown in block 306.

With reference to FIG. 4, FIG. 4 a process flow diagram for another method of detecting valuable sections within a web page according to another example of the present disclosure. The method of FIG. 4, which is also referred to as log synthesizing herein, can be applied in case that there is an access record of the same page in the user log, i.e. the same webpage from which a valuable section is to be detected has been visited before, and its access records are stored in the user log as XPaths. For example, a users' selection is saved as XPath: HTML/BODY/DIV[1]/DIV[2].

Different people may select different valuable sections in the same page, but there are still some sections that most users consider to be useful. The target of log synthesizing is to find out those commonly acknowledged useful sections and put forward them to users. The result of log synthesizing may return a set of XPaths which can represent users' common ideas of valuable sections. To calculate such common sections, a similar measure between XPaths need to defined first. According to an example, a measure of tag edit distance is used to measure the similarity between two XPaths.

The tag edit distance is an extension of edit distance. A tag in an XPath is regarded as a basic element and divides the XPath by ‘/’. When calculating a tag edit distance, the update and insert operations are only used because other operations like delete may result in the loss of tag relative information. Two XPaths are compared tag by tag. If two tags are equal then proceed to the next tag, otherwise one tag is updated to make them equal or a new tag is inserted at the end of the shorter XPath if it has no tag to compare with. At last one gets two same XPaths and the number of needed operations of this process. For example, assuming that there are two XPaths, XPath1: HTML/BODY/DIV[1] and XPath2; HTML/BODY/DIV[2]/DIV[1], in order to change XPath1 to XPath2, the DIV[1] tag in XPath1 should be updated and a DIV[1] should be inserted at the end of XPath1. The needed operation number is 2. This number is defined herein as an example of the tag edit distance between two XPaths.

For a webpage, it has record sets of several users {R1, R2 . . . Rn} and each user selects several sections in the page which represent as XPaths in a user log Ri={x1, x2 . . . xn}. As shown in block 401 of FIG. 4, the union set and intersection set of all the XPaths in the user log are computed. For example, the union set is computed as Xu={Xu1, Xu2 . . . Xun} and the intersection set is computed as Xi={Xi1, Xi2 . . . Xim}. Then, as shown in block 402, a valuable section in the webpage is detected based on a similarity measure between the union set and the intersection set. As can be appreciated, if the intersection set equals the union set, it means that all users select the same sections from this page. Thus, according to an example, the similarity between the union and intersection sets can be used to measure whether a record of a page should be put forward to users or not. According to an example, the similarity measure between the union set and the intersection set is dependent on at least one of the following factors: the tag edit distance between paths in the intersection set and paths in the subtraction set of the intersection set and the union set, the number of paths in the intersection set, the number of tags comprised in a path, and the number of paths in the subtraction set. According to an example, the similarity measure between the union set and the intersection set can be defined according to the following formula:

$$Similarity ( {X}_{i} , {X}_{u} ) = 1 - \frac{1}{\vert {X}_{i} \vert} {\sum }_{j} {\sum }_{t} \frac{min ( Tdistance ( {X}_{ij} , {X}_{st} ) )}{max ( \vert {X}_{ij} \vert , \vert {X}_{st} \vert )}$$

Where Tdistance is the tag edit distance between jth XPath in the intersection set Xᵢ and tth XPath in the subtraction set of Xᵤ and Xⱼ, |Xᵢⱼ| is the number of tags in this XPath. |Xᵢ| is the number of XPaths in intersection set Xᵢ, Xₛₜ is the tth XPath in the subtraction set, and |Xₛₜ| is the number of tags in this XPath. Here, the subtraction set is used instead of union set because the intersection set is a subset of the union set and the minimal distance will be 0 if XPaths in intersection set are not removed from the union set.

According to the above formula, a similarity score can be calculated for all the same pages in the log. According to an example of the disclosure, a threshold τ can be set for the similarity measure. If Similarity(Xi, Xu)>τ then the user is recommended with the intersection set Xi because the XPaths in intersection can reflect most users' idea of valuable section and XPaths in subtraction set are only slight adjustment of common valuable sections. If Similarity(Xi, Xu)<τ, it means that users have significantly different ideas about which sections are valuable so recommendations should not be made to the user, instead a page-based tool can be used to select valuable sections, as shown in block 306 of FIG. 3.

With reference to FIG. 5, FIG. 5 is a process flow diagram for yet another method of detecting valuable sections within a web page according to yet another example of the present disclosure. The method of FIG. 5 can be applied in case that there is no access record of the same page in the user log, i.e. the same webpage from which a valuable section is to be detected has not been visited before, but there are webpages similar to this webpage that have been visited before.

For a new-coming page, since there is no previous record in the user log, so it is impossible to recommend valuable sections in this page to a user only by log synthesizing. According to an example of the present disclosure, a weighted tag tree based method is proposed to recommend valuable sections by leveraging user log of similar web pages. A set of XPaths of each section in the new-coming page is first generated for the new-coming page, as shown in block 501. Then, a weighted tag tree is generated based on the XPaths of the similar webpages in the user log, as shown in block 502 and described in detail below.

Since similar web pages detection is not the focus of this disclosure, we suppose that a set of similar pages {Ps1, Ps2, . . . , Psn} for a new coming page Pnew has been obtained. Then a weighted tag tree from selected records in this similar page set is constructed, wherein “selected” means that a user selects a section as a valuable section. These records are converted into a tree by the following process. Since all XPaths begin with a tag “HTML”, “HTML” is set as root of the tree. Then each selected XPath is scanned, each tag of the XPath is set as the subtree of its previous tag, and if there exists the same tag in the same position, then the count of this node is added by one, which count is used as the weight for the node. That is, a weight of each tag in the weighted tag tree is the number of times that the tag appears at a same position in all the paths constituting the weighted tag tree. For example, there are 4 selected XPaths:

1: HTML/BODY/DIV[0]/DIV/H1[0]

2: HTML/BODY/DIV[0]/DIV[1]

3: HTML/BODY/DIV[0]/H1[0]

4: HTML/BODY/DIV[1]

The resulting weighted tag tree of these XPaths is shown in FIG. 6.

After the weight tag tree is constructed, a valuable section is detected from the new-coming page based on comparison between the weight tag tree and each of XPaths in the set generated for the new-coming page, as shown in block 503. Specifically, detecting a valuable section based on comparison between the weight tag tree and each of XPaths in the set generated on the new-coming page includes: letting each XPath go through the weight tag tree; summing the weights of nodes that are passed by the XPath as a score of the XPath; and detecting a valuable section in the webpage based on the value of the score.

For example, a new coming page has the following XPath sequences:

.HTML/BODY/DIV[0]/DIV[0]/H1[0]

.HTML/BODY/DIV[1]/DIV[2]

.HTML/BODY/DIV[0]/DIV[0]/DIV[1]/P1[1]

.HTML/BODY/DIV[0]/DIV[1]

Let them go through the weighted tag tree shown in FIG. 6. For each XPath, tags in this XPath are compared with tags in the weighted tag tree tag by tag. If two tags are equal, then compare the next tag in the XPath with a node in the subtree, put the tag into recommend XPath and add the weight (i.e. count number) of the node to the score of this tag, until the XPath ends or there is no tag in the weighted tag tree that is equal to the current tag of the XPath. Taking the above XPath sequences for example, the bold tags below are those that can go through the tree. The score of each XPath is calculated and shown on the right of each XPath.

| | |
|---|---|
| HTML/BODY/DIV[0]/DIV[0]/H1[0] | 13 |
| HTML/BODY/DIV[1]/DIV[2] | 9 |
| HTML/BODY/DIV[0]/DIV[0]/DIV[1]/P1[1] | 12 |
| HTML/BODY/DIV[0]/DIV[1] | 12 |

Once the score of each XPath is calculated, a valuable section in the webpage can be detected based on the scores. For example, a section the score of whose XPath is the highest or sections whose scores are higher than a predefined threshold can be detected and recommended to the user.

However, if we simply sum the scores of nodes that are passed by an XPath into the score of this XPath, it will result in a situation that the longer an XPath is, the higher its score is. Therefore, according to an example of the present disclosure, the score ears be adjusted based on at least one of the following factors: the number of nodes in the weighted tag tree, the average length of paths that constitute the weighted tag tree, and the length of XPath that goes through the weighted tag tree. According to an example, the score can be adjusted according to the following formula:

$${Score}_{final} = \frac{{\sum }_{i} {Score}_{node}}{{( \vert {Length}_{average} - {Length}_{XPath} \vert + 1 )}^{2}}$$

Wherein Score_{node} is the count number in nodes, Length_{average} is the average length of XPaths, which constitute the weighted tag tree and Length_{XPath} is the length of XPath that goes through the weighted tag tree.

Through this adjustment, the more the length of an XPath is close to the average length, the less its penalty is. In this way, the score of long XPaths and XPaths whose length are close to the average length of XPaths in weighted tag tree can be adjusted. This is a reasonable adjustment because few valuable sections in a webpage can be too big or too small, that is to say, the recommended XPath should not be too long nor too short but within a appropriate length. After adjustment, the scores are changed as following:

| | |
|---|---|
| HTML/BODY/DIV[0]/DIV[0]/H1[0]I | 3.25 |
| HTML/BODY/DIV[1]/ | 2.25 |
| HTML/BODY/DIV[0]/DIV[0]/ | 12 |
| HTML/BODY/DIV[0]/DIV[1] | 12 |

Then, by example, the third and forth XPath can be detected as a valuable section and recommended to the user.

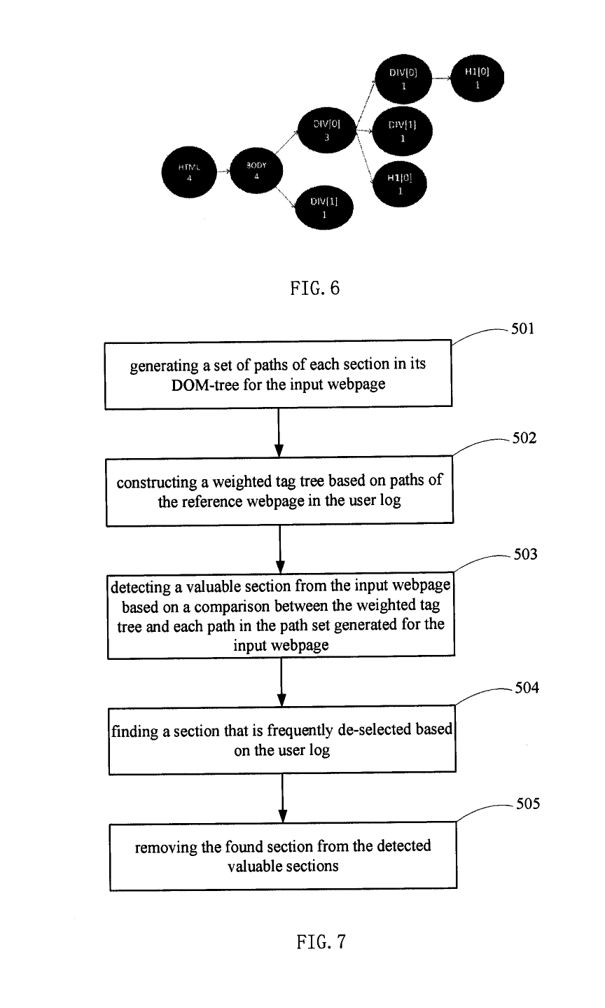

With reference to FIG. 7, FIG. 7 is a process flow diagram for another method of detecting valuable sections within a web page according to another example of the present disclosure. The method of FIG. 7 can also be applied in case that there is no access record of the same page in the user log, but there are webpages similar to this webpage that have been visited before. As shown, the method of FIG. 7 is identical to the method of FIG. 5, except that the method in FIG. 7 further comprises two additional block 504 and 505.

In this example, in addition to an XPath of a section that was visited by a user previously (i.e. the user selects this section as a valuable section) in the DOM-tree, the user log further includes an XPath of a section that was de-selected by a user previously (i.e. the user considers this section as a useless section or a low value section) in the DOM-tree that represents the webpage. The result of recommendation would be more meaningful if these low-value sections are removed from the results of detection at block 503. As shown in block 504, those sections that are frequently de-selected by the user are found based on the user log. According to an example, the number of each de-selected XPath is counted and the sections the number of which exceeds a predetermined threshold are retrieved as representing low-value sections. Then, as shown in block 505, these found sections are removed from the valuable sections detected in block 503.

Some experiments are carried out by using the primary smart print tool as reference to evaluate the above described process. FIG. 9(a) and 9(b) shows the recommending results for the same web pages by the original smart print and the method of the present disclosure respectively. From the comparisons, it can be seen that the log-based method cart achieve more accuracy recommendation for users.

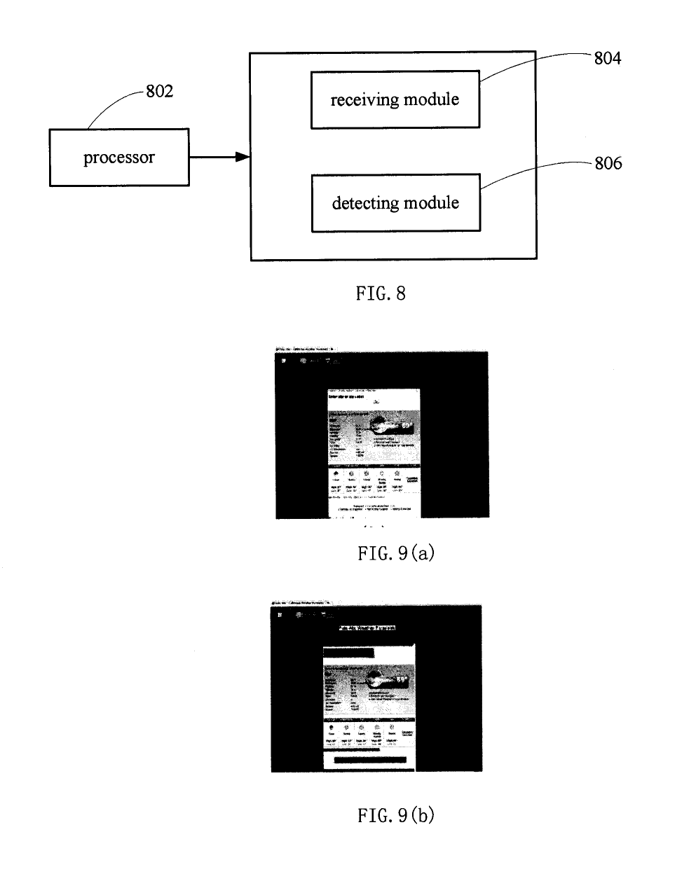

With reference to FIG. 8 now, FIG. 8 is a block diagram showing a non-transitory, computer-readable medium that stores code for detecting valuable sections within a web page according to an example of the present disclosure. The non-transitory, computer-readable medium is generally referred to by the reference number 800.

The non-transitory, computer-readable medium 800 may correspond to any typical storage device that stores computer-implemented instructions, such as programming code or the like. For example, the non-transitory, computer-readable medium 800 may include one or more of a non-volatile memory, a volatile memory, and/or one or more storage devices. Examples of non-volatile memory include, but are not limited to, electrically erasable programmable read only memory (EEPROM) and read only memory (ROM). Examples of volatile memory include, but are not limited to, static random access memory (SRAM), and dynamic random access memory (DRAM). Examples of storage devices include, but are not limited to, hard disks, compact disc drives, digital versatile disc drives, and flash memory devices.

A processor 802 generally retrieves and executes the computer-implemented instructions stored in the non-transitory, computer-readable medium 800 for detecting valuable sections on a web page. At block 804, a receiving module may receive an input webpage from which valuable sections therein may be detected. At block 806, a detecting module may detect valuable sections in the input webpage based on a user log of a reference webpage associated with the input webpage, as described above.

From the above depiction of the implementation mode, the above examples can be implemented by hardware, software or firmware or a combination thereof. For example the various methods, processes, modules and functional units described herein max be implemented by a processor (the term processor is to be interpreted broadly to include a CPU, processing unit, ASIC, logic unit, or programmable gate array etc.) The processes, methods and functional units may all be performed by a single processor or split between several processors. They may be implemented as machine readable instructions executable by one or more processors. Further the teachings herein may be implemented in the form of a software product. The computer software product, is stored in a storage medium and comprises a plurality of instructions for making a computer device (which can be a personal computer, a server or a network device, etc.) implement the method recited in the examples of the present disclosure.

The figures are only illustrations of an example, wherein the modules or procedure shown in the figures arc not necessarily essential for implementing the present disclosure. Moreover, the sequence numbers of the above examples are only for description, and do not indicate an example is more superior to another.

Those skilled in the art can understand that the modules in the device in the example can be arranged in the device in the example as described in the example, or can be alternatively located in one or more devices different from that in the example. The modules in the aforesaid example can be combined into one module or further divided into a plurality of sub-modules.

1. A method for detecting a valuable section within a web page, comprising:
receiving an input webpage; and
detecting a valuable section in the input webpage based on a user log of a reference webpage associated with the input webpage, wherein said user log comprises a path of a section within the reference webpage that was accessed by a user in a DOM-tree that represents said reference webpage.

2. The method of claim 1, wherein the reference webpage associated with the input webpage is the same webpage as the input one, and said detecting a valuable section in the input webpage further comprises:
computing a union set and an intersection set of all the paths related to the reference webpage in the user log; and
detecting a valuable section in the input webpage based on a similarity measure between the union set and the intersection set.

3. The method of claim 2, wherein said method further comprises:
setting a similarity threshold; and if the similarity measure is above the similarity threshold, detecting a section represented by the intersection set as a valuable section in the input webpage.

4. The method of claim 2, wherein said similarity measure is dependent on the following factors: the tag edit distance between paths in the intersection set and paths in the subtraction set of the intersection set and the union set, the number of paths in the intersection set, the number of tags comprised in a path, and the number of paths in the subtraction set.

5. The method of claim 1, wherein the reference webpage associated with the input webpage is a webpage similar to the input one, and said detecting a valuable section in the input webpage further comprises:
generating a set of paths of each section in the input webpage in its DOM-tree for the input webpage;
constructing a weighted tag tree based on paths of the reference webpage in the user log; and
detecting a valuable section from the input webpage based on a comparison between the weighted tag tree and each path in the path set generated for the input webpage.

6. The method of claim 1, wherein a weight of each tag in the weighted tag tree is the number of times that said tag appears at a same position in all the paths constituting the weighted tag tree and wherein said detecting a valuable section from the input webpage based on a comparison between the weighted tag tree and each path in the path set generated for the input webpage further comprises:
letting each XPath go through the weighted tag tree;
summing the weights of tags that are passed by said Path as a score of said path; and
detecting a valuable section in the input webpage based on the value of the score.

7. The method of claim 6, wherein the score of each path can be adjusted based on the following factors: the number of tags in the weighted tag tree, the average length of paths that constitute the weighted tag tree, and the length of said path that goes through the weighted tag tree.

8. The method of claim 5, wherein said user log further comprises a path of a section in the reference webpage that was de-selected by a user in the DOM-tree that represents the reference webpage and said method further comprises:
finding a section that is frequently de-selected based on the user log; and
removing the found section from the detected valuable sections.

9. The method of claim 8, wherein said finding a section that is frequently de-selected comprises: counting the number of a path represents each de-selected section and finding a section said number of which exceeds a predetermined threshold.

10. A system for detecting a valuable section within a web page, the system comprising:
a processor that is adapted to execute stored instructions; and
a memory device that stores instructions, the memory device comprising processor-executable code, that when executed by the processor, is adapted to:
receive an input webpage; and
detect a valuable section in the input webpage based on a user log of a reference webpage associated with the input webpage, wherein said user log comprises a path of a section within the reference webpage that was accessed by a user in a DOM-tree that represents said reference webpage.

11. The system of claim 10, wherein the reference webpage associated with the input webpage is the same webpage as the input one, and the memory stores processor-executable code adapted to detect a valuable section in the input webpage by:
computing a union set and an intersection set of all the paths related to the reference webpage in the user log; and
detecting a valuable section in the input webpage based on a similarity measure between the union set and the intersection set.

12. The system of claim 11, wherein the memory stores processor-executable code adapted to: set a similarity threshold; and if the similarity measure is above the similarity threshold, detect a section represented by the intersection set as a valuable section in the input webpage.

13. The system of claim 2, wherein said similarity measure is dependent on the following factors: the tag edit distance between paths in the intersection set and paths in the subtraction set of the intersection set and the union set, the number of paths in the intersection set, the number of tags comprised in a path, and the number of paths in the subtraction set.

14. The system of claim 10, wherein the reference webpage associated with the input webpage is a webpage similar to the input one, and the memory stores processor-executable code adapted to detect a valuable section in the input webpage by:
generating a set of paths of each section in the input webpage in its DOM-tree for the input webpage;
constructing a weighted tag tree based on paths of the reference webpage in the user log; and
detecting a valuable section from the input webpage based on a comparison between the weighted tag tree and each path in the path set generated for the input webpage.

15-18. (canceled)

19. A non-transitory, computer-readable medium, comprising code configured to direct a processor to:
receive an input webpage; and
detect a valuable section in the input webpage based on a user log of a reference webpage associated with the input webpage, wherein said user log comprises a path of a section within the reference webpage that was accessed by a user in a DOM-tree that represents said reference webpage.

20. The non-transitory, computer-readable medium of claim 19, wherein the reference webpage associated with the input webpage is the same webpage as the input one, and the non-transitory, computer-readable medium comprises code configured to direct a processor to detect a valuable section in the input webpage by:
computing a union set and an intersection set of all the paths related to the reference webpage in the user log; and
detecting a valuable section in the input webpage based on a similarity measure between the union set and the intersection set.

21. The non-transitory, computer-readable medium of claim 20, further comprising code configured to direct a processor to:
set a similarity threshold; and if the similarity measure is above the similarity threshold, detect a section represented by the intersection set as a valuable section in the input webpage.

22. The non-transitory, computer-readable medium of claim 20, wherein said similarity measure is dependent on the following factors: the tag edit distance between paths in the intersection set and paths in the subtraction set of the intersection set and the union set, the number of paths in the intersection set, the number of tags comprised in a path, and the number of paths in the subtraction set.

23. The non-transitory, computer-readable medium of claim 19, wherein the reference webpage associated with the input webpage is a webpage similar to the input one, and the non-transitory, computer-readable medium comprises code configured to direct a processor to detect a valuable section in the input webpage by:
generating a set of paths of each section in the input webpage in its DOM-tree for the input webpage;
constructing a weighted tag tree based on paths of the reference webpage in the user log; and
detecting a valuable section from the input webpage based on a comparison between the weighted tag tree and each path in the path set generated for the input webpage.

24. The non-transitory, computer-readable medium of claim 19, wherein a weight of each tag in the weighted tag tree is the number of times that said tag appears at a same position in all the paths constituting the weighted tag tree and wherein the non-transitory, computer-readable medium comprises code configured to direct a processor to detect a valuable section from the input webpage based on a comparison between the weighted tag tree and each path in the path set generated for the input webpage by:
letting each XPath go through the weighted tag tree;
summing the weights of tags that are passed by said Path as a score of said path; and
detecting a valuable section in the input webpage based on the value of the score.

25-27. (canceled)
